(19) United States
(12) Patent Application Publication
(10) Pub. No.: US 2004/0017735 A1
(43) Pub. Date: Jan. 29, 2004

(54) Portable electronic apparatus

(76) Inventors: Susumu Kotanagi, Chiba-shi (JP); Hiroshi Kawamata, Chiba-shi (JP); Hiroshi Igarashi, Chiba-shi (JP)

Correspondence Address: ADAMS & WILKS, 31st Floor, 50 Broadway, New York, NY, 10004, US

(21) Appl. No.: 10/438,039

(22) Filed: May 14, 2003

(30) Foreign Application Priority Data
May 20, 2002 (JP) 2002-144960

(51) Int. Cl. G04B 37/00

(52) U.S. Cl. 368/276

(57) ABSTRACT

To provide a portable electronic apparatus formed so that the dimensions of a case can be held down to minimum levels as compared with those of an electronic apparatus body. A portable electronic apparatus, such as a wristwatch has a case made of a one-end-opened bottomed cylindrical body, a pin type engaging portion fixed to a bottom wall, projecting from this bottom wall into the interior of the case and toward an opening of the case and provided with an engaging projection on a projecting end section of the pin type engaging portion, and a block type apparatus body provided in a bottom wall thereof with a hole to be engaged into which the pin type engaging portion is inserted, and provided in a circumferential wall of the hole with a portion to be engaged to be engaged with which the projection of the pin type engaging portion is engaged when the apparatus body is placed in a predetermined position in the case. The pin is made of, for example, a split pin provided with an expanding slot.

### BACKGROUND OF THE INVENTION

This invention relates to a portable electronic apparatus, such as a wristwatch.

A wristwatch provided with a case including a bottomed cylindrical body which is formed by making a case back and a case band integral with each other, and which is opened at an upper end thereof is known (for example, JP-A-H09-189776). The wristwatch proposed in JP-A-H09-189776 is formed by providing a recess in an inner circumferential surface of the case band of the case, and a projection, which is engaged with the recess, on an outer circumferential surface of a module, in such a manner that the module is fixed to the case band of the case by engaging the projection on the outer circumferential surface of the module with the recess in the inner circumferential surface of the case band of the case during the insertion of the module from the upper end opening of the case into the interior of the case.

However, in a wristwatch having an engaging structure between an inner circumferential surface of a case band of a case and an outer circumferential surface of a module, the sizes of the case in a plane perpendicular to an axis thereof increase by levels corresponding to those of an area occupied by the engaging structure as compared with a diametrical size of the module.

The present invention is made in view of this point, and an object thereof is to provide a portable electronic apparatus formed so that the sizes of a case can be reduced to minimum levels as compared with those of the electronic apparatus.

### SUMMARY OF THE INVENTION

In order to achieve this and other objects of the present invention, the portable electronic apparatus according to the invention has a case made of a one-end-opened bottomed cylindrical body, an engaging means fixed to a bottom wall of the case, projecting from the bottom wall into the interior of the case and toward an opening of the case and provided at a projecting end section of the engaging means with an engaging portion, and a block type apparatus body provided in a bottom surface thereof with a hole to be engaged into which the engaging means is inserted, and further provided in a circumferential wall of the hole with a portion to be engaged with which the engaging portion of the engaging means is engaged when the block type apparatus body is placed in a predetermined position in the interior of the case. The engaging means may also be made of a split pin constituting a pin type engaging means.

The portable electronic apparatus according to the present invention is provided with “an engaging means fixed to a bottom wall of the case, projecting from the bottom wall into the interior of the case and toward an opening of the case and provided at a projecting end section of the engaging means with an engaging portion, and a block type apparatus body provided in a bottom surface thereof with a hole to be engaged into which the engaging means is inserted, and further provided in the hole with a portion to be engaged with which the engaging portion of the engaging means is engaged when the block type apparatus body is placed in a predetermined position in the interior of the hole”. Therefore, the block type apparatus body can be engaged with and fixed to the case with the engaging portion of the engaging means engaged with the portion to be engaged of the hole to be engaged. Since the hole to be engaged of the block type apparatus body in this arrangement is formed in a bottom surface thereof with the engaging means projecting from the bottom wall of the case into the interior thereof and toward the opening of the case, it is not necessary to provide additionally an engaging structure for the apparatus body between an outer circumferential surface of the apparatus body and an inner circumferential surface of the case. This enables the sizes of the case to be minimized with respect to the diametrical size (size in a plane perpendicular to an axis connecting the bottom and top surfaces of the apparatus body) of the block type apparatus body. In other words, the sizes of the block type apparatus body can be increased to maximum levels with respect to those of the case. Furthermore, since the portion to be engaged, which is engaged with the engaging portion of the engaging means, is formed in the hole to be engaged of the block type apparatus body, the sizes of the apparatus body in the direction of the height thereof can also be minimized. As a result, the case for the portable electronic apparatus can be formed to such smallest possible sizes that are needed to have the case surround the electronic apparatus body. Although the engaging portion in this arrangement is typically a projection or a hook with the portion to be engaged made of a recess engaged with the engaging portion, the engaging portion and the portion to be engaged may be made of a recess and a projection respectively when occasion demands. Furthermore, the block type apparatus body can be fixed to the bottom wall of the case via the engaging portion engaged with the portion to be engaged in the hole to be engaged of the apparatus body. Therefore, even when the portable electronic apparatus receives an external force and vibration during the transportation thereof, the apparatus can be retained by the case. Accordingly, the possibility that the apparatus body is damaged can be minimized.

As long as the case is made of a bottomed cylindrical body provided at one end side thereof with a bottom wall, and at the other end side thereof with an opening, the shape of the cylinder may be a circular shape, an angularly cylindrical shape, or other shape. Namely, a horizontal sectional shape of the case may be a circular shape, a polygonal shape, such as a quadrangular shape, and other shape, such as an elliptic shape. As long as the apparatus body can be inserted into and taken out from the opening of the case, the shape and dimensions of a cross section perpendicular to the axial direction of the cylinder may be constant or may be varied depending upon a position in the direction of an extension of the same axis. Although the length of the case in the direction of the axis thereof is typically small (thin) as compared with the size of the opening thereof, the height (depth) of the case may be set larger than the size of the opening thereof if desired. In the following paragraphs of this specification, the opening-carrying side and the “bottom wall”-carrying side of the case will be called “upper side” and “lower side” respectively in some cases for convenience of description, but the opening may be positioned vertically lower than the bottom wall depending upon the mode of use of the electronic apparatus.

The bottom wall is provided with such a flange-like wall portion that projects into the interior of the case so as to inhibit at least the insertion and withdrawal of the apparatus body thereinto and therefrom. However, the bottom wall may be provided with one or more openings like a battery take-out port allowing the insertion and withdrawal of a part like, for example, a battery thereinto and therefrom and capable of being closed with a small cover, such as a battery cover. In this case, in the portable electronic apparatus, the bottom wall has a bottom wall body, and a battery cover detachable with respect to the bottom wall body so that the battery cover opens and closes the battery take-out port of the bottom wall body.

The hole in the bottom wall of the apparatus body may be a blind hole not opened in a top surface of the apparatus body as long as the hole is opened in a bottom surface of the apparatus body and extends from the bottom surface toward the interior of the apparatus body. However, typically, this hole is made of a through hole extending to the top wall of the apparatus body and is opened in the top surface thereof. In this case, the sizes and shape of the engaging means and hole to be engaged may be set in advance so that the engagement of the projection-like engaging portion of the engaging means and the portion to be engaged like the recess of the hole to be engaged with each other can be cancelled by inserting a rod-like operating means from the top surface into the apparatus body. Namely, it is allowable to make the hole to be engaged of a through hole form the engaging portion of the engaging means on the part of the engaging means which is distant from the projecting end section thereof, and form long and narrowly the portion of the engaging means which is in the vicinity of the end edge of the projecting end section so that the engaging means is inserted from the top surface-side opening of the through hole to reach the portion of the hole corresponding to the portion of the engaging means which is in the vicinity of the end edge, i.e., the engaging means is inserted easily into the hole.

The hole to be engaged of the apparatus body is typically positioned on the inner side of the outer circumferential wall of the apparatus body, and the whole circumference of the circumferential wall of the hole to be engaged is surrounded by a part of the apparatus body. However, a part of the circumferential wall of the hole to be engaged may be opened in the circumferential surface of the apparatus body when occasion demands as long as the engaging means is positioned within the range of extent of the bottom surface of the apparatus body.

Although one set of hole to be engaged and engaging means may serve the purpose, two or more sets of these parts are typically provided so that the apparatus body can be firmly retained by the case. When a plurality of sets of hole to be engaged and engaging means are provided, the shape (thickness, length, horizontal sectional shape, etc.) of the hole to be engaged and engaging means in each set may be identical or different in a certain portion thereof.

The engaging means is typically like, for example, a split pin. In such a case, the engaging means typically has an engaging projection practically over the whole circumference thereof, or over the portion of the circumferential surface which is positioned on the opposite side of a central groove of the split pin. In this case, the engaging means is formed easily to a shape which permits the engagement and the releasing of the engagement of the engaging means to be carried out easily. An engaging projection may be formed, for example, on one side surface of the projecting end section of the engaging means.

The engaging means may be formed in one body with respect to the case by a process, such as integral molding or cutting, etc., or may be fixed to the bottom wall of the case via other fixing means as long as a base end portion of the engaging means is substantially fixed to the bottom wall of the case. In the latter case, for example, a portable electronic apparatus has a retainer plate fixed to a bottom wall of a case, and an engaging means is fixed to the bottom wall by the retainer plate. In this case, the retainer plate is fixed to the bottom wall by other retainer plate fixing means. This retainer plate fixing means can include, for example, an opening or a through hole made therein, and a projecting portion inserted through the through hole. In this case, the projecting portion inserted through the through hole of the retainer plate is deformed and diametrically thickened by calking and the like, and the retainer plate is thereby fixed directly or indirectly to the bottom wall. The calking may be either the thermal calking or the mechanical calking.

In this embodiment, the portable electronic apparatus may be either a wristwatch type electronic timepiece or other portable information terminal. When the portable electronic apparatus is made of an electronic timepiece, a block type apparatus body is necessarily made of a module of an electronic timepiece.

### BRIEF DESCRIPTION OF THE DRAWINGS

A preferred embodiment of the invention will now be described with reference to the accompanying drawings wherein:

FIG. 1 is a sectional explanatory drawing (a sectional view taken along the line I-I in FIG. 3) of a wristwatch type electronic timepiece as a preferred embodiment of the portable electronic apparatus according to the present invention;

FIG. 2 is a sectional explanatory drawing taken along the line II-II in FIG. 3 of the electronic timepiece of FIG. 1;

FIG. 3 is an explanatory drawing in plan (in this drawing, the timepiece is shown with glass, hands and a dial removed) of the electronic timepiece of FIG. 1;

FIG. 4 is an enlarged sectional explanatory drawing similar to the sectional view of FIG. 1 and showing a part of a modified example of an engaging structure of the module of the electronic timepiece of FIG. 1;

FIG. 5 is a sectional explanatory drawing (a sectional view taken along the line V-V in FIG. 6) similar to FIG. 1 and showing another modified example of the electronic timepiece of FIG. 1; and

FIG. 6 is an explanatory drawing in plan similar to FIG. 2 and showing the electronic timepiece of FIG. 5.

### DETAILED DESCRIPTION OF THE PREFERRED EMBODIMENTS

Some of the preferred modes of embodiment of the invention will be described on the basis of the preferred embodiment shown in the attached drawings.

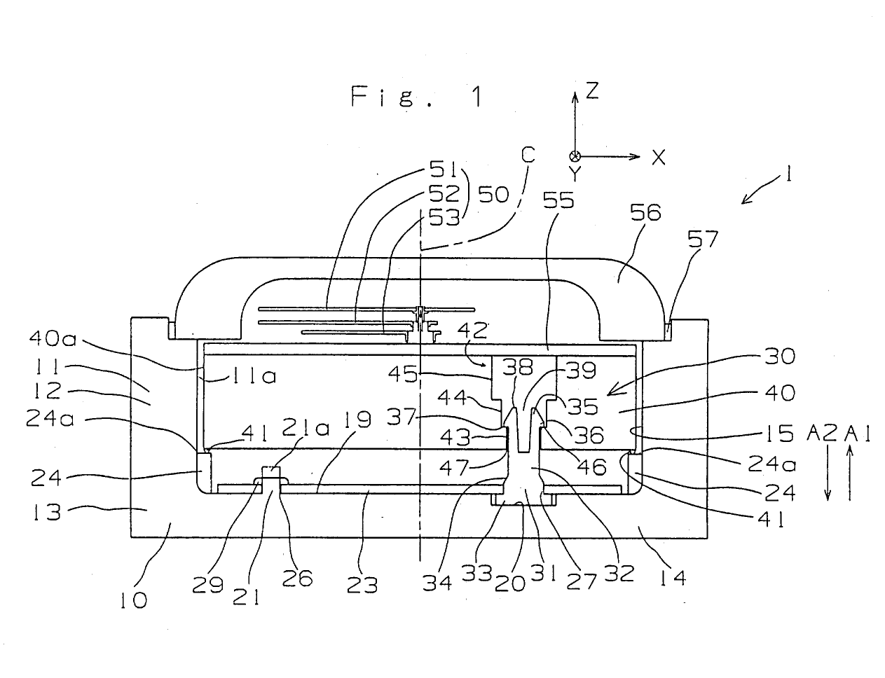

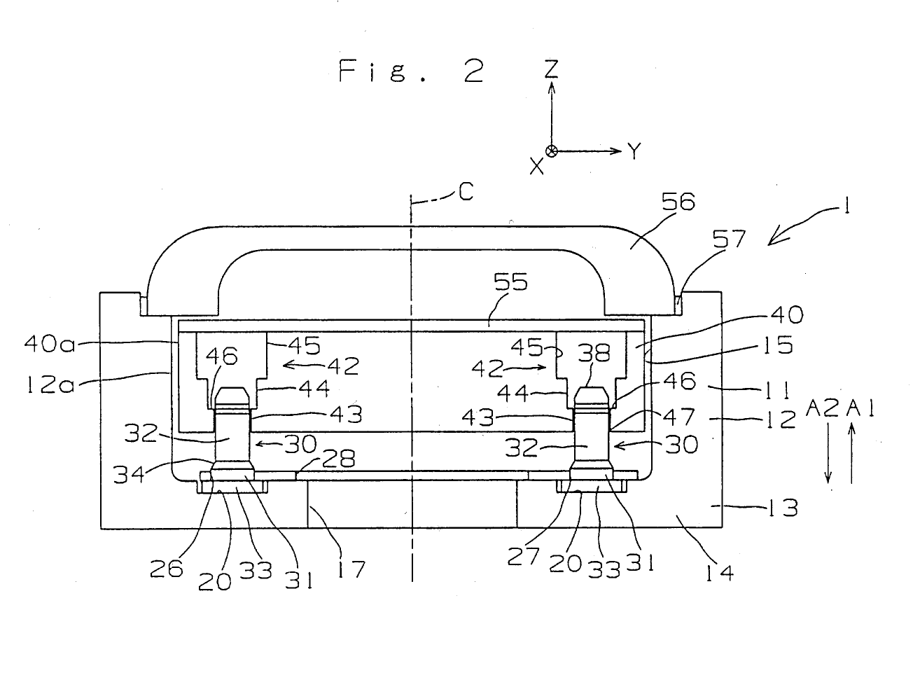

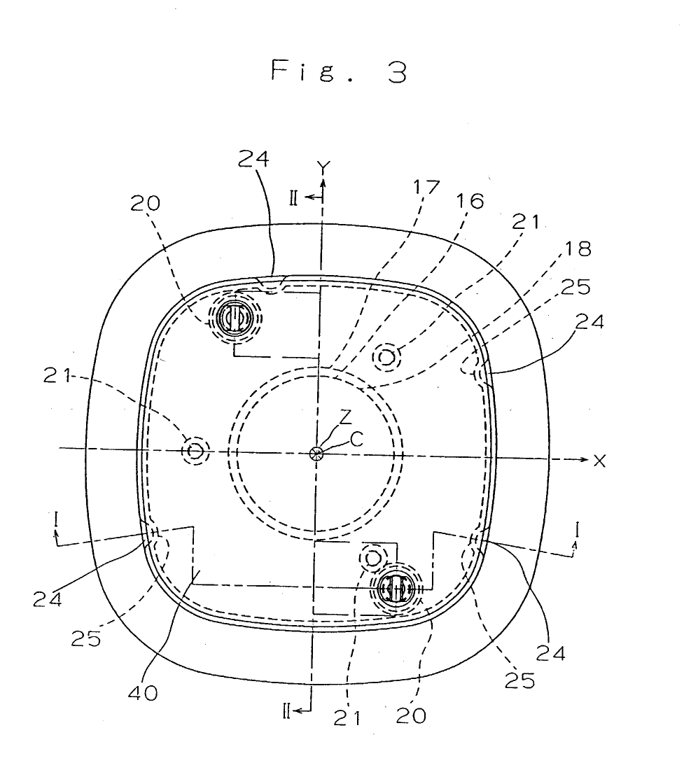

FIGS. 1 to 3 show a wristwatch type portable electronic timepiece 1 as a first preferred embodiment of the present invention. The electronic timepiece 1 has a case 10 and a module 40, and also needles 50, such as a second hand 51, a minute hand 52 and an hour hand 53, a dial 55 and glass (transparent plate) 56 on the front side.

The case 10 has a case body 12 including a small-height cylindrical circumferential wall portion 11, and a bottom wall portion 14 made integral at a lower end section 13 of the circumferential wall portion 11 with the circumferential wall portion 11. The circumferential wall portion 11 and bottom wall portion 14 form a chamber 15 in which the module 40, etc. are housed.

An opening 17 allowing the insertion and withdrawal of a battery 16 into and from the interior of the chamber 15 is formed in the bottom wall 14 of the case body 12, and the opening 17 is closed with a battery cover 18 fitted removably in the bottom wall 14. Therefore, in this example, the case 10 includes the case body 12 and battery cover 18.

In the following paragraphs, three-dimensional orthogonal coordinates X-Y-Z fixed to the case 10 for convenience of description will be discussed. Assume that an X-axis and a Y-axis extend along an extension surface of the bottom wall 14 with a Z-axis extending forward in the perpendicular direction with respect to the same extension surface.

As long as the case 10 in the shape of a bottomed cylindrical body is provided with the bottom wall portion 14 extending like a flange in the direction in which an X-Y plane extends, an opening other than the battery inserting opening 17 may be formed in a part of the bottom wall portion 14. As long as a projection in the Z direction of the bottom wall portion 14 has a significant extension on the X-Y plane, the bottom wall portion 14 need not be parallel to the X-Y plane.

The bottom wall 14 has in a plurality (two positions at diagonal or diametrical directions in the illustrated example) of positions on an inner surface 19 thereof defining the chamber 15 module fixing pin setting recesses 20, and in a plurality (three positions in the illustrated example) of circumferentially spaced directions calk-engaging pins 21 as fixed plate positioning guide pins in a substantially equally spaced manner. When the case 10 is made of a thermoplastic resin, the engaging pins 21 are made of thermally calking pin-like small projections molded so as to be integral with the bottom wall 14. The engaging pins 21 may be formed engageably by a means, such as screws which are other than the calking method.

In the illustrated example, a circumferential portion 11 of the case 10 or the case body 12 has a quadrangular cylindrical shape rounded at corner sections thereof, and the bottom wall 14 a quadrangular plate-like shape rounded at corner sections thereof. Therefore, although the module fixing pin setting recesses 20 are formed in positions in the vicinity of a diagonal line of the quadrangular shape, other arbitrary positions may be substituted for the diagonal positions as long as the substitutive positions are within the range of extension of the bottom wall 14 facing the chamber 15, and convenient for supporting the module 40. Although two module fixing pin setting recesses 20 are formed in the illustrated example, the number of such recesses may be either one or not smaller than three as long as the module 40 is fixed in the chamber 15. The arrangement of these recesses in a case where the recesses are formed in a plurality of positions can also be selected arbitrarily as long as the positions enables the module 40 to be fixed effectively in the chamber 15, and the module 40 to be bored.

A module fixing pin 30 as the engaging means has a base-end-side larger-diameter portion 31, a free-end-side smaller-diameter portion 32, a collar- or flange-like section 33 at a base end of the larger-diameter portion 31, a frusto-conical guide connecting section 34 connecting the larger-diameter portion 31 and smaller-diameter portion 32 together, and a substantially frusto-conical section 35 at a free end of the smaller-diameter portion 32. A diameter of a base-end-side annular larger-diameter part 36 of the frusto-conical section 35 is larger than that of the smaller-diameter portion 32. This annular larger-diameter part 36 forms a projection or hook as the engaging portion projecting radially outward, and has an annular surface to be engaged or an annular engaging end surface 37 at the side of a base end thereof. The module fixing pin 30 is further provided with an expanding slot 39 extending from a free end surface 38 to an intermediate section of the smaller-diameter portion 32. One or both of the larger-diameter portion 31 and frusto-conical guide connecting section 34 need not be provided. In such a case, the smaller-diameter portion 32 is connected to the flange-like portion 33 via a non-omitted one of the larger-diameter portion 31 and frusto-conical guide connecting section 34 or directly. The thickness of the flange-like portion 33 substantially agrees with the depth of the recess 20.

The module fixing pin 30 is fixed to the bottom wall 14 via a reinforcing plate or a fixed plate 23. The fixed plate 23 has a contour identical on an X-Y plane with that of the chamber 15 or bottom wall portion 14 so that the fixed plate is just placed on the bottom wall portion 14 in the chamber 15. The fixed plate 23 also has a plurality of small holes 26 in which the guide pins 21 on the bottom wall portion 14 are fitted, and a plurality of larger-diameter holes 27, each of which is just fitted around the larger-diameter portion 31 of the module fixing pin 30, in the positions aligned with those in which the guide pins 21 and module fixing pins 30 are set up. The diameter of the larger-diameter holes 27 is so large that permits the same holes 27 to be just fitted around the larger-diameter portions 31 of the module fixing pins 30, and typically almost equal to or larger than that of the annular larger-diameter portion 36 at the base end side of the frusto-conical section 35 of the module fixing pin 30. However, the diameter of the larger-diameter holes 27 may be smaller than that of the larger-diameter portion 36 as long as the frusto-conical section 35 with the expanding slot 39 of the larger-diameter portion 36 in the shape of a split pin in a narrowed condition can be inserted into the larger-diameter hole 27. The fixed plate 23 is provided with a large opening 28, which permits a battery to be inserted into and withdrawn from the case, in the position on the fixed plate 23 which corresponds to the battery port 17 of the bottom wall portion 14.

The case 10 is provided on a plurality of portions of an inner surface of the circumferential wall 11 thereof with module receivers or module receiving bases 24, on which the module 40 is placed, so as to project into the interior of the chamber 15. Accordingly, the fixed plate 23 is provided in a circumferential surface thereof with positioning recesses 25 adapted to receive the projection-like module receiving bases 24, in such a manner that the fixed plate 23 is fitted in a corner-rounded quadrangular cylindrical region defined by the circumferential wall portion 11 in the chamber 15.

In order to fix the module fixing pins 30, each module fixing pin 30 is placed on the inner surface 19 of the bottom wall portion 14 so that the flange-like portion 33 at the base end of the pin 30 is engaged with the recess 20 of the bottom wall portion 14, and then the fixed plate 23 is placed on the bottom wall portion 14 in the chamber 15 so that each module fixing pin 30 is fitted in each larger-diameter hole 27 of the fixed plate 23; each guide pin 21 is fitted in each smaller-diameter hole 26; and each recess 25 of the fixed plate 23 is engaged with each projection-like module receiving base 24. The fixed plate 23 is thereby positioned with respect to the case 10 so that each smaller-diameter hole 26 is fitted with each guide pin 21 and recess 25 is engaged with projection-like module receiving base 24. Since the larger-diameter portion 31 of the module fixing pin 30 is fitted in the larger-diameter hole 27 of the fixed plate 23, the module fixing pin 30 is positioned in the X-Y plane perpendicular to the Z-axis aligned with the central axis C with respect to the case 10. A diameter-increased calked portion 29 is then formed by thermally calking the projecting end portion 21a (shown in phantom in FIG. 1) of each guide pin 21, and the fixed plate 23 is thereby fixed to the bottom wall portion 14. The module fixing pin 30 is fixed at the larger-diameter portion 31 and flange-like portion 33 thereof to the bottom wall portion 14 via the fixed plate 23.

The module 40 is formed so that the module is pressed by a crushed projection 41 at a bottom portion of the case against a top surface 24a of the projection-like receiving base 24, which projects from the circumferential wall portion 11 slightly into the chamber 15, and thereby placed in the case. The module 40 has in its body portion a through hole 42 as a hole to be engaged in and with which the module fixing pin 30 is fitted and engaged. The position of each through hole 42 on a plane parallel to the X-Y plane is aligned with that of the relative module fixing pin 30. Conversely speaking, the through hole 42 is formed in the region of the module 40 which permits a hole like the through hole 42 to be made, and the module fixing pin 30 is set in the position which is aligned with the through hole 42 in a plane parallel to the X-Y plane. Of course, the design and arrangement of each part of the module 40 are to be suitably selected for forming the fixing hole 42. However, securing regions, the width of each of which corresponds to the thickness of each of the module fixing pins 30, in a scattering manner on a plane parallel to the X-Y plane without taking the direction of an external force exerted on the module 40 in a plane parallel to the X-Y plane into consideration serves the purpose as compared with a case where an attempt to secure a space, which is occupied by a module locking structure, between the outer circumferential surface of the module 40 and the inner circumferential surface the circumferential wall 11 of the body 12 of the case 10. Therefore, it is easy to secure regions for making holes therein.

Each fixing hole 42 has a comparatively smaller-diameter hole portion 43, a comparatively larger-diameter hole portion 44 joined to the smaller-diameter hole portion 43, and a further larger-diameter hole portion 45 joined to the intermediate-diameter hole portion 44. Between the smaller-diameter hole portion 43 and the intermediate-diameter hole portion 44 as a portion to be engaged or a recess to be engaged, an annular stepped portion or an annular end surface 46 defining a bottom surface of the recess 44 and constituting an engaging surface is formed. The intermediate-diameter hole portion 44 has such a diameter that permits the larger-diameter portion 36 of the module fixing pin to be held freely therein with the expanding slot 39 of the module fixing pin 30 opened. When occasion demands, the inner diameter of the intermediate-diameter hole portion 44 may be set slightly smaller than the outer diameter of the freely opened larger-diameter portion 36. The smaller-diameter hole portion 43 has such a diameter that permits the larger-diameter portion 36 of the module fixing pin 30 to be forced into the smaller-diameter hole portion 43 of the module 40 (relatively) in the A1 direction as the expanding slot 39 of the module fixing pin 30 constituting a split pin is crushed (in other words, the smaller-diameter hole portion 43 has a diameter that permits the smaller-diameter hole portion 43 of the module 40 to be engaged with the larger-diameter portion 36 of the module fixing pin 30 (relatively) in the A2 direction); and such a diameter that permits the annular end surface 37 of the larger-diameter portion 36 of the module fixing pin 30 to impinge upon the annular stepped portion or end surface 46 of the fixing hole 42 when the larger-diameter portion 36 reaches the interior of the intermediate-diameter hole portion 44 with the expanding slot 39 once opened, and a slip of the module fixing pin 30 in the A2 direction to be thereby inhibited. The diameter of the intermediate-diameter hole portion 44 need not be fixed, the diameter of the larger-diameter hole portion 45 may be the same as that of intermediate-diameter hole portion 44, as long as end surface 46 is provided.

Therefore, in order to set the module 40 in the case, the module 40 is fitted in the chamber 15 with the locking pin 30 fixed to the case 10 via the fixed plate 23 so that the engaging pin 30 projects from the bottom wall 14 into the chamber 15, and the module 40 is moved with respect to the case 10 in the A2 direction. The bottom opening 47 of the smaller-diameter hole portion 43 of each hole 42 of the module 40 is fitted around the module fixing pin 30, and the module 40 is further forced into the case 10 in the A2 direction. As a result, the module fixing pin 30 is inserted into the hole 42 of the module 40 as the module fixing pin 30 is elastically deformed at the projections 35, 36, etc. so that the expanding slot 39 is crushed in the diametrical direction of the pin 30. This pin inserting operation is carried out as the projection 41 to be crushed is slightly crushed, until the larger-diameter portion 36 of the split pin 30 reaches the intermediate-diameter hole portion 44 of the hole 42 to cause the expanding slot 39 of the pin 30 to be substantially opened. When the larger-diameter portion 36 of the split pin 30 reaches the intermediate-diameter hole portion 44 of the hole 42, the larger-diameter portion 36 returns elastically toward the diametrical original position, and the annular end surface 47 of the larger-diameter portion 36 becomes possible to engage or contact the annular stepped portion 46 of the hole 42. A slip of the module 40 with respect to the case 10 in the A1 direction is then restricted or inhibited, and the locking of the module 40 is completed. When the annular end surface 37 of the larger-diameter portion 36 of the module fixing pin 30 is just engaged with or stopped by the surface 46 to be engaged of the hole 42 of the module 40, the projection 41 to be crushed is slightly crushed, and the height in the Z-direction of the end surface 24a of the receiving base 24, the height in the Z-direction of the engaging surface 37 of the module fixing pin 30, the depth in the Z-direction of the recess 20 and the position in the Z-direction (the length in the Z-direction of the smaller-diameter hole portion 43) of the surface 46 to be engaged of the hole 42 of the module 40 is selected and regulated in advance so that the relative displacement or play (floating in the A1 direction of the module 40) in the A1 and A2 directions, with respect to the module 40 with respect to the case 10 is restricted or inhibited. However, when the height of the projection 41 to be crushed is set to a certain level, an error corresponding to the height is allowed. When a plurality of module fixing pins 30 are provided, the lengths and thicknesses of the relative parts thereof may be equal to or different from each other.

Since the pin 30 and hole 42 to be engaged are positioned in the interior of the body of the module 40, i.e., since the pin 30 and hole 42 are positioned in the range of extent of the module 40 in a plane parallel to the X-Y plane, it is unnecessary that a special space for providing an engaging structure be secured between the inner surface 11a of the circumferential wall 11 of the case 10 and the outer circumferential surface 40a of the module 40 so as to secure a space for the module fixing pin 30 and module fixing hole 42. As a result, when the circumferential wall 11 of the case 10 has minimum dimensions defined by the outer circumference 40a of the module 40, the requirements are met.

In the illustrated example, the receiving bases 24 have a considerably large height. However, when the thickness of the timepiece with a battery held therein can be minimized, the height of each receiving base 24 may be set small, or the receiving base 24 may be practically omitted. In such a case, for example, the projection 41 to be crushed may be adapted to be pressed against, for example, the thermally calked head portion 29 of the guide pin 21. In order to avoid an increase in the height of the timepiece due to the existence of the head portion 29, the projection 41 to be crushed may be formed so that the projection 41 is pressed directly against the upper surface of the fixed plate 23. The upward and downward supporting of the module will be described. When a space for supporting the module fixing pin 30 projecting from the bottom wall 14, fitted in the interior of the module 40 and engaged with the module 40 in the interior thereof is merely secured in a position in the vicinity of the bottom wall portion 14 in any of these cases instead of providing a Z-direction support structure on both an upper part and a lower part (both the bottom wall 14 and the dial 55 or the glass plate 56) so as to position and retain the module 40 in the Z-direction, the upward and downward supporting of the module can be attained at once. Therefore, it is possible to support the module 40 in the vertical direction while minimizing the height (height in the Z-direction) of the chamber 15. Furthermore, regarding the retention of the module 40, there is not the possibility that a separating force in the A2 direction be exerted on the glass plate 56, so that there is little fear of a decrease in the waterproofing performance of a seal member, etc. such as the packing 57.

In this electronic timepiece 1, the module fixing pin 30 and module fixing hole 42 are engaged with each other. This enables the height of the timepiece 1 (size in the Z-direction) to be minimized as the size of the timepiece 1 in the direction along the X-Y direction is minimized. Moreover, the setting and engaging of the module 40 in and with the case can be done easily.

The larger-diameter hole portion 45 of a maximum diameter of the fixing hole 42 is a hole for suitably allowing the insertion thereinto of a tool and the like for picking the larger-diameter head portion 35 of the split pin 30 so as to crush the expanding slot 39 in the diametrical direction when the split pin 30 is withdrawn (module 40 is withdrawn in the A1 direction with respect to the case 10 provided with the split pin 30) from the module 40 in the A2 direction. This larger-diameter hole portion 45 may be formed in some cases even to a diameter both equal to and smaller than that of the intermediate-diameter hole portion 44, and also eccentrically with respect to the intermediate-diameter hole portion 44 as long as the removing of the module 40 can be done. When it is not necessary to remove the module 40 which has once set in the case, the larger-diameter hole portion 45 need not be provided. In such a case, the hole portion 45 is, for example, completely closed, and the fixing hole 42 necessarily employ a mode of a blind hole opened at a lower end 47 only.

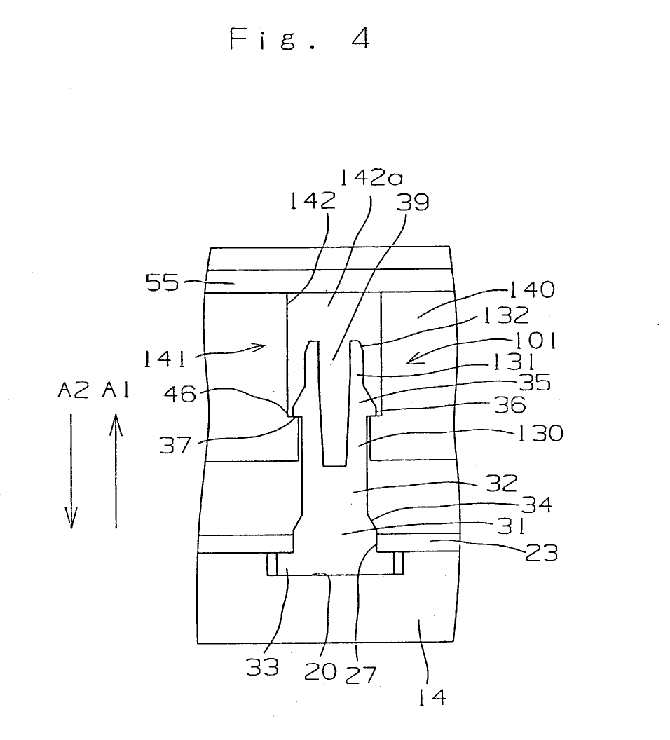

A structure for easily releasing the engagement of the module fixing pin of a mode of a split pin may be formed in the split pin. An example of such a split pin is shown in FIG. 4. Referring to FIG. 4, the same reference numerals are added to the members and portions identical with or equivalent to those shown in FIGS. 1 to 3.

In a locking structure 101 of FIG. 4, a module fixing pin 130 of a mode of a split pin has at the side of a free end of a frusto-conical insert-engaging portion 35 thereof a further smaller-diameter cylindrical holding portion 131, a free end section of which further has a frusto-conical tapering portion 132. The other portions of the module fixing pin 130 are formed in substantially the same manner as the corresponding portions of the module fixing pin 30. An upper end-side larger-diameter hole portion 45 of a hole 42 of a module 140 has the same diameter as an intermediate-diameter hole portion 44, and the hole portions 44, 45 as a whole form one larger-diameter hole portion 142. The other sections of the module 140 are formed in substantially the same manner as the module 40.

In order to release the engaging of the module fixing pin 130 in this case, a suitable picking tool and the like is inserted from a free end opening 142a of the larger-diameter hole portion 142 of a module fixing hole 141 into the interior of the same hole portion 142 in the A2 direction, and a holding portion 131 is picked so as to narrow an expanding slot 39, the engagement of an end surface 37 of a larger-diameter portion 36 and end surface 46 of a smaller-diameter portion 43 being thus released. The module 140 in this condition may be withdrawn with respect to the case 10 in the A1 direction.

As long as the module fixing pin can be engaged in the hole of the module with a wall portion of the hole, the module fixing pin may be a pin provided with an engaging projection, for example, at one side thereof instead of the split pin.

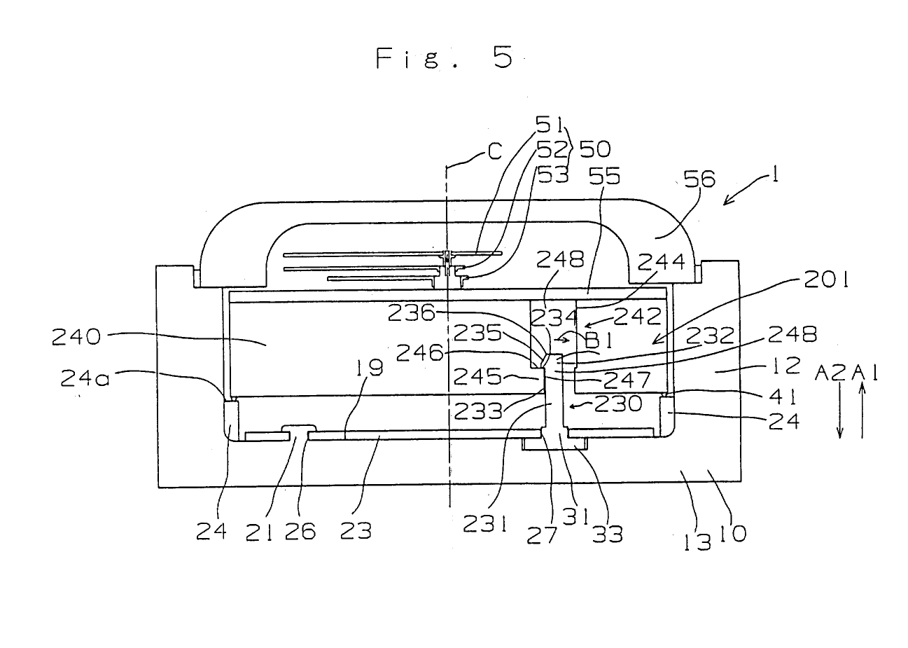

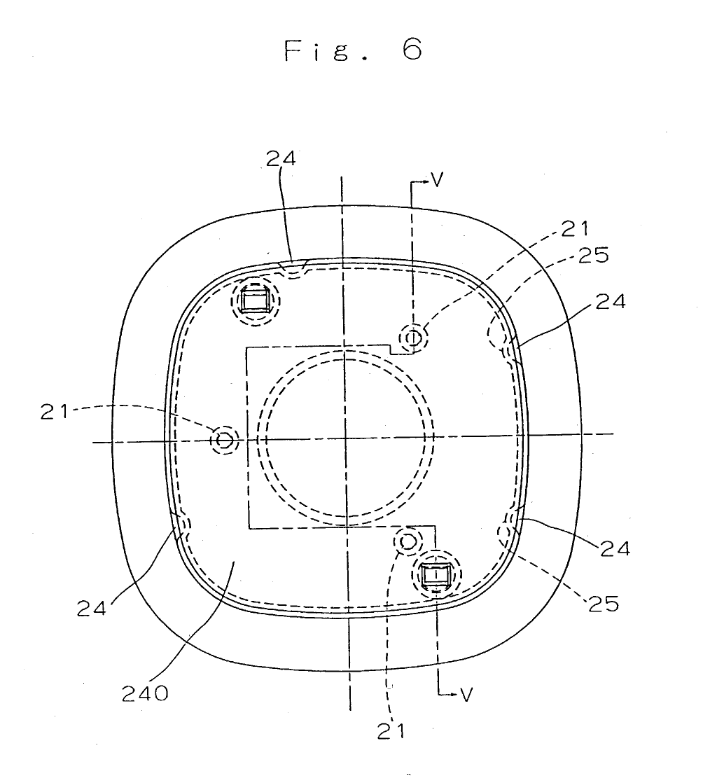

For example, in an engaging structure 201 shown in FIGS. 5 and 6, a module fixing pin 230 is provided in addition to a flange-like portion 33 and a larger-diameter portion 31 with a thinner columnar portion 231. This columnar portion 231 has on one-side surface 233 of a free end section 232 thereof an engaging projection 235 provided with an engaging surface 234. The engaging projection 235 is provided with a tapering portion 236 at a free end section on a side surface 233 thereof. Although the columnar portion 231 having the engaging projection may be cylindrical, the columnar portion 231 may also be, for example, angularly cylindrical instead as shown in the drawing. A module fixing hole 242 is formed so as to provide therein with a larger-diameter portion 244, a projection 245 extending toward a lower end, i.e. a bottom surface of the larger-diameter portion 244, and a surface to be engaged or a stopper surface 246 on an upper end-side of the projection 245 (In other words, the larger-diameter hole portion 244 constitutes a recess to be engaged, and an end surface of the recess 244 a surface to be engaged). In such a case, the projection 245 is to define one side surface of a smaller-diameter hole portion 248 at a lower end-side of the fixing hole 242. The projection 245 in an engaged state is engaged at a projecting end surface 247 thereof with the side surface 233 of the module fixing pin 230, and engageable at the surface to be engaged or stopper surface 246 thereof with that 234 of the engaging projection 235.

When the module 240 is pressed down in the A2 direction in such a case with respect to the case 10, the module fixing pin 230 is inserted from the smaller-diameter hole 248 into the module fixing hole 242. At this time, the tapering portion 236 impinges upon the lower end portion of the projection 245 of the hole 242, and is bent in the B1 direction. The engaging projection 235 of the module fixing pin 230 then runs over the projection 245 of the module fixing hole 242 and fits in the hole portion 244. In such an engaged condition, a slip of the module 240 from the case 10 in the A1 direction is inhibited as shown in FIGS. 5 and 6, owing to the engagement of the stopper surface 234 of the engaging projection 235 and the stopper surface or a hooking bottom surface 246 of the projection 245 with each other. Thus, the module 240 can be kept in an engaged condition with respect to the case 10. In order to remove the module 240 from the case 10 in the A1 direction, a tool and the like is inserted from the upper end opening 248 of the hole portion 244, and the engaging projection 235 of the module fixing pin 230 is thereby bent in the B1 direction. The module 240 may then be withdrawn from the case 10 with the engagement of the stopper surfaces 234, 246 in a released state.

Although the part-engaging direction in such a case of one-sided engagement of parts may be, for example, the same direction, an opposite direction and a crossing direction, the direction in which a slip and displacement of parts are minimized owing to, for example, the cooperation of other fitted parts and engaged parts, and in which the engagement and disengagement of parts become easy, is selected.

In the above-described electronic apparatus, the engaging portion of the module fixing pin as the engaging means and the portion to be engaged of the hole to be engaged may have any shape and construction as long as the engaging means can be engaged with an inner portion of the hole to be engaged. The engaging portion may have a projection, and the portion to be engaged a recess shaped complementarily to the projection. The engaging portion may have a recess, and the portion to be engaged a projection shaped complementarily to this recess. The engaging portion and the portion to be engaged may respectively have a recess and a projection and a projection and a recess shaped complementarily to each other.

What is claimed is:

1. A portable electronic apparatus comprising:
a case made of a one-end-opened bottomed cylindrical body;
an engaging means fixed to a bottom wall of the case;
projecting from the bottom wall into the interior of the case and toward an opening of the case and provided at a projecting end section of the engaging means with an engaging portion; and
a block type apparatus body provided in a bottom surface thereof with a hole to be engaged into which the engaging means is inserted, and further provided in a circumferential wall of the hole with a portion to be engaged with which the engaging portion of the engaging means is engaged when the block type apparatus body is placed in a predetermined position in the interior of the case.

2. A portable electronic apparatus according to claim 1, wherein the engaging means is made of a split pin constituting a pin type engaging means.

3. A portable electronic apparatus according to claim 1, wherein the engaging portion is formed on one side surface of the projecting end section of the engaging means.

4. A portable electronic apparatus according to claim 1, wherein the hole to be engaged is made of a through hole, the engaging portion of the engaging means being formed on the part thereof which is distant from an end edge of the projecting end section, the part of the projecting end section of the engaging means which is in the vicinity of the end edge being formed long and narrowly so that the engaging means is inserted easily from a top surface-side opening of the through hole thereinto to the portion thereof which corresponds to the section of the engaging means which is in the vicinity of the end edge thereof.

5. A portable electronic apparatus according to claim 1, wherein the case has therein a retainer plate fixed to the bottom wall thereof, the engaging means being fixed to the bottom wall via the retainer plate.

6. A portable electronic apparatus according to claim 1, wherein the bottom wall has a bottom wall body provided with a battery take-out port, and a battery cover detachable with respect to the bottom wall body so as to open and close the battery take-out port of the bottom wall body.

7. A portable electronic apparatus according to claim 1, wherein the block type apparatus body is made of a module of an electronic timepiece, the portable electronic apparatus being made of an electronic timepiece.
